(19) United States
(12) Patent Application Publication
(10) Pub. No.: US 2020/0070389 A1
(43) Pub. Date: Mar. 5, 2020

(54) DEVICE, SYSTEM AND METHOD FOR MODELING FIBER ORIENTATION DISTRIBUTION

(71) Applicant: CORETECH SYSTEM CO., LTD., CHUPEI CITY (TW)

(72) Inventors: HUAN-CHANG TSENG, CHUPEI CITY (TW); RONG-YEU CHANG, CHUPEI CITY (TW); CHIA-HSIANG HSU, CHUPEI CITY (TW)

(21) Appl. No.: 16/254,038

(22) Filed: Jan. 22, 2019

Related U.S. Application Data
(60) Provisional application No. 62/725,953, filed on Aug. 31, 2018.

(51) Int. Cl. B29C 45/00; B29C 45/76; G06F 17/50

(52) U.S. Cl. CPC B29C 45/0005; B29C 45/7693; G06F 2217/41; B29C 2945/76103; B29C 2945/76588; G06F 17/5009

(57) ABSTRACT

A device, a system and a method for modeling fiber orientation distribution related to an injection molding object are provided. The device of the system obtains an aspect ratio of a non-cylindrical fiber, and inputs the aspect ratio and fiber data of the non-cylindrical fiber into an orientation distribution generation model for outputting a non-cylindrical fiber orientation distribution. The device determines whether the non-cylindrical fiber orientation distribution corresponds to a predetermined orientation distribution.

### PRIORITY CLAIM AND CROSS-REFERENCE

This application claims the priority benefit of U.S. provisional patent application No. 62/725,953, filed on Aug. 31, 2018. The entirety of the above-mentioned patent application is hereby incorporated by reference herein and made a part of this specification.

### TECHNICAL FIELD

The present disclosure relates to a device, a system and a method for modeling fiber orientation distribution related to an injection molding object using a computer-aided engineering (CAE) simulation.

### DISCUSSION OF THE BACKGROUND

Fiber-reinforced thermoplastic (FRT) composites have been introduced in the technology of injection molding and have been commercially available in the field of automotive industries. Normally, FRT composites include general fibers that are in the shape of a rod. Recently, flat fibers, whose cross sections are similar to a rectangle, are developed for being used in FRT composites. Due to the properties of the flat fibers, using the FRT composites with flat fibers to form an injection molding object can greatly reduce warpage of the injection molding object. However, because there is incomplete understanding of the FRT composites with flat fibers, it is difficult to model the warpage of an injection molding object formed by the FRT composites with flat fibers.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a device for modeling fiber orientation distribution related to an injection molding object. The device includes an input interface and a processor. The input interface and the processor are connected electrically. The input interface receives geometry data and fiber data of a non-cylindrical fiber. The processor calculates an aspect ratio of the non-cylindrical fiber based on the geometry data; and derives a non-cylindrical fiber orientation distribution by inputting the aspect ratio and the fiber data of the non-cylindrical fiber into an orientation distribution generation model, wherein the non-cylindrical fiber orientation distribution matches a predetermined orientation distribution

In some embodiments of the present disclosure, the processor further derives warpage data of the injection molding object by inputting the non-cylindrical fiber orientation distribution and the aspect ratio to a deformation model.

In some embodiments of the present disclosure, the device further includes a memory. The memory is connected to the processor electrically and stores the orientation distribution generation model and the deformation model.

In some embodiments of the present disclosure, the geometry data further includes a fiber length of the non-cylindrical fiber, a cross-sectional area of the non-cylindrical fiber and a perimeter of a cross section of the non-cylindrical fiber. The aspect ratio is calculated based on the following formula:

$$R = \frac{{L}_{F}}{( \frac{4 \times A}{P} )}$$

where R represents the aspect ratio, L_{F} represents the fiber length, A represents the cross-sectional area and P represents the perimeter.

In some embodiments of the present disclosure, the fiber data includes a fiber-to-fiber interaction parameter, a fiber-to-polymer interaction parameter, and a fiber slow-down rate parameter.

In some embodiments of the present disclosure, the non-cylindrical fiber orientation distribution matches the predetermined orientation distribution based on a cylindrical fiber orientation distribution.

In some embodiments of the present disclosure, the predetermined orientation distribution and the cylindrical fiber orientation distribution include flow direction orientation distributions.

Orientation tensor components of the predetermined orientation distribution are less than or equal to corresponding orientation tensor components of the cylindrical fiber orientation distribution at different thicknesses.

In some embodiments of the present disclosure, the predetermined orientation distribution and the cylindrical fiber orientation distribution include cross-flow direction orientation distributions. Orientation tensor components of the predetermined orientation distribution are greater than or equal to corresponding orientation tensor components of the cylindrical fiber orientation distribution at different thicknesses.

One aspect of the present disclosure provides an injection molding system. The injection molding system includes a mold, a molding machine, a computing device and a controller. The mold has a mold cavity. The molding machine fills the mold cavity with a composite molding resin including a polymeric material having a plurality of non-cylindrical fibers, wherein the non-cylindrical fibers have geometry data. The computing device includes a memory, an input interface and a processor. The memory, the input interface and the processor are connected electrically. The memory stores an orientation distribution generation model. The input interface receives the geometry data and fiber data of the non-cylindrical fibers. The processor calculates an aspect ratio of the non-cylindrical fibers based on the geometry data; and derives a non-cylindrical fiber orientation distribution by inputting the aspect ratio and the fiber data of the non-cylindrical fiber into the orientation distribution generation model, wherein the non-cylindrical fiber orientation distribution matches a predetermined orientation distribution. The controller is connected to the computing device and controls the molding machine to perform an actual molding for injecting the composite molding resin into at least a portion of the mold cavity based on the non-cylindrical fiber orientation distribution.

In some embodiments of the present disclosure, the memory further stores a deformation model. The processor further derives warpage data of an injection molding object by inputting the non-cylindrical fiber orientation distribution and the aspect ratio to the deformation model. The controller further controls the molding machine to perform the actual molding based on the non-cylindrical fiber orientation distribution and the warpage data

One aspect of the present disclosure provides a method for modeling fiber orientation distribution related to an injection molding object. In some embodiments, the method includes: obtaining an aspect ratio of a non-cylindrical fiber; inputting the aspect ratio and first fiber data of the non-cylindrical fiber into an orientation distribution generation model for outputting a non-cylindrical fiber orientation distribution; and determining whether the non-cylindrical fiber orientation distribution corresponds to a predetermined orientation distribution.

In some embodiments of the present disclosure, the method further includes: inputting the non-cylindrical fiber orientation distribution and the aspect ratio to a deformation model for outputting warpage data of the injection molding object.

In some embodiments of the present disclosure, obtaining the aspect ratio further includes: receiving geometry data of the non-cylindrical fiber, and calculating the aspect ratio of the non-cylindrical fiber based on the geometry data.

In some embodiments of the present disclosure, the geometry data further includes a fiber length of the non-cylindrical fiber, a cross-sectional area of the non-cylindrical fiber and a perimeter of the cross section of the non-cylindrical fiber. The aspect ratio is derived based on the following formula:

$$R = \frac{{L}_{F}}{( \frac{4 \times A}{P} )}$$

where R represents the aspect ratio, L_{F} represents the fiber length, A represents the cross-sectional area and P represents the perimeter.

In some embodiments of the present disclosure, the first fiber data includes a fiber-to-fiber interaction parameter, a fiber-to-polymer interaction parameter and a fiber slow-down rate parameter.

In some embodiments of the present disclosure, the predetermined orientation distribution is established according to a cylindrical fiber orientation distribution.

In some embodiments of the present disclosure, the predetermined orientation distribution and the cylindrical fiber orientation distribution include flow direction orientation distributions. An orientation tensor component of the flow direction orientation distribution of the predetermined orientation distribution is less than or equal to an orientation tensor component of the flow direction orientation distribution of the cylindrical fiber orientation distribution at a thickness.

In some embodiments of the present disclosure, the predetermined orientation distribution and the cylindrical fiber orientation distribution include cross-flow direction orientation distributions. An orientation tensor component of the cross-flow direction orientation distribution of the predetermined orientation distribution is greater than or equal to an orientation tensor component of the cross-flow direction orientation distribution of the cylindrical fiber orientation distribution at a thickness.

In some embodiments of the present disclosure, the method further includes: inputting the aspect ratio and second fiber data of the non-cylindrical fiber into the orientation distribution generation model for updating the non-cylindrical fiber orientation distribution; and determining whether the non-cylindrical fiber orientation distribution corresponds to the predetermined orientation distribution.

Accordingly, as for an injection molding object made of composite molding resin with non-cylindrical fibers, corresponding fiber orientation distribution may be modeled. Further, warpage data may be modeled as well. Therefore, deformation (correlated with the modeled fiber orientation distribution and warpage data) may be simulated before performing the actual molding.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIGS. 1A and 1B are schematic views of an injection molding system in accordance with various embodiments of the present disclosure.

FIGS. 2A and 2B are block diagrams of a computing device in accordance with various embodiments of the present disclosure.

FIG. 3A illustrates a perspective view of a non-cylindrical fiber in accordance with various embodiments of the present disclosure.

FIG. 3B illustrates a cross section of a non-cylindrical fiber in accordance with various embodiments of the present disclosure.

FIG. 3C illustrates a perspective view of a non-cylindrical fiber in accordance with various embodiments of the present disclosure.

FIG. 4A is a graph of flow direction orientation distribution and predetermined orientation distribution against a thickness of the injection molding object in accordance with an embodiment of the present disclosure.

FIG. 4B is a graph of cross-flow direction orientation distribution and predetermined orientation distribution against a thickness of the injection molding object in accordance with an embodiment of the present disclosure.

FIG. 5A is a graph of predetermined orientation distribution and cylindrical fiber orientation distribution in format of flow direction orientation distributions in accordance with an embodiment of the present disclosure.

FIG. 5B is a graph of predetermined orientation distribution and cylindrical fiber orientation distribution in format of cross-flow direction orientation distributions in accordance with an embodiment of the present disclosure.

FIG. 5C is a graph of predetermined orientation distribution and cylindrical fiber orientation distribution based on the aspect of the shell-core structure in accordance with an embodiment of the present disclosure.

FIG. 5D is a graph of predetermined orientation distribution and cylindrical fiber orientation distribution based on the aspect of the shell-core structure in accordance with an embodiment of the present disclosure.

FIG. 6 is a flowchart showing a method for modeling warpage of an injection molding object in accordance with some embodiments of the present disclosure.

FIG. 7 is a flowchart showing a method for modeling warpage of an injection molding object in accordance with some embodiments of the present disclosure.

FIG. 8 is a flowchart showing a method for modeling warpage of an injection molding object in accordance with some embodiments of the present disclosure.

FIG. 9 is a flowchart showing a method for modeling warpage of an injection molding object in accordance with some embodiments of the present disclosure.

FIG. 10A is a schematic view of a simulated injection molding object with warpage data generated based on orientation distribution and aspect ratio corresponding to cylindrical fibers in accordance with some embodiments of the present disclosure.

FIG. 10B is cross section of the simulated injection molding object with warpage data generated based on orientation distribution and aspect ratio corresponding to cylindrical fibers in accordance with some embodiments of the present disclosure.

FIG. 10C is a schematic view of a simulated injection molding object with warpage data generated based on orientation distribution and aspect ratio corresponding to non-cylindrical fibers in accordance with various embodiments of the present disclosure.

FIG. 10D is cross section of the simulated injection molding object with warpage data generated based on orientation distribution and aspect ratio corresponding to non-cylindrical fibers in accordance with some embodiments of the present disclosure.

FIGS. 11A and 11B are schematic views of a genuine domain of an injection molding object with a fan-gated plaque geometry in accordance with some embodiments of the present disclosure.

FIG. 12 is a flowchart showing an integration of the non-cylindrical fiber orientation prediction technique and the CAE software in accordance with some embodiments of the present disclosure.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a method, a device and a system for modeling fiber orientation distribution related to an injection molding object using a computer-aided engineering (CAE) simulation. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

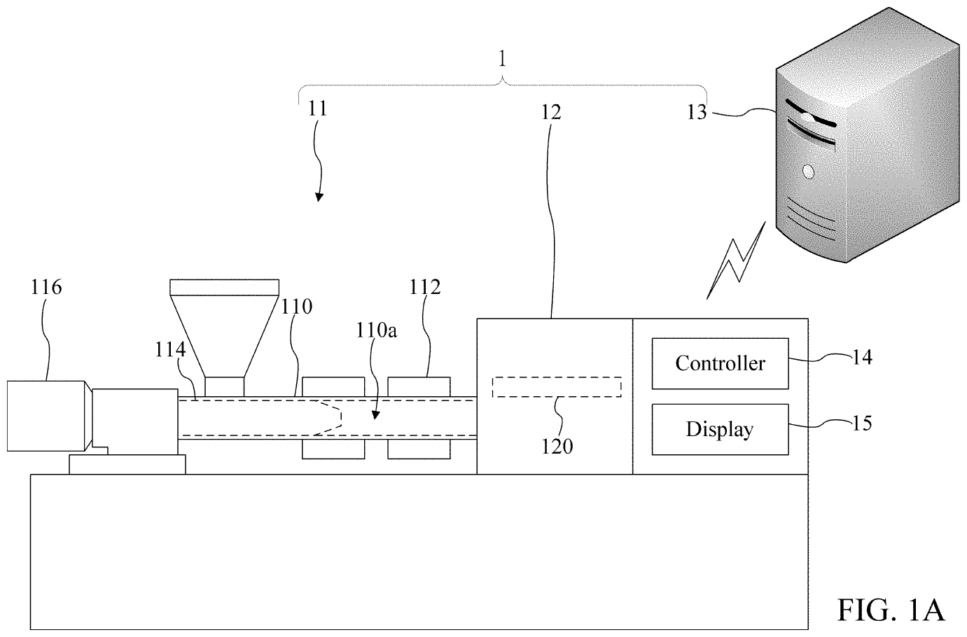

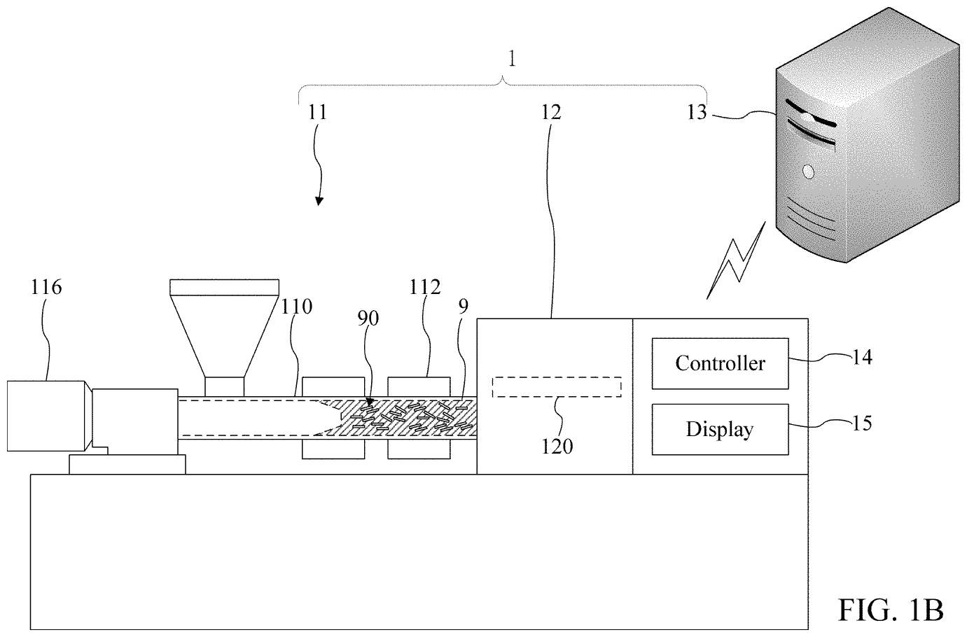

FIGS. 1A and 1B are schematic views of an injection molding system 1 in accordance with various embodiments of the present disclosure. The injection molding system 1 includes a molding machine 11 such as an injection molding machine, a mold 12 disposed on the molding machine 11, and a computing device 13 connected to the injection molding machine 11. In some embodiments of the present disclosure, the injection molding machine 11 includes a barrel 110 having a screw chamber 110a, heating elements 112 configured to heat the screw chamber 110a of the barrel 110, and a screw 114 positioned in the screw chamber of the barrel 110 and driven by a screw-driving motor 116 for feeding composites into a mold cavity 120 of the mold 12. In some embodiments of the present disclosure, the injection molding system 1 has a controller 14 configured to control the operation of the injection molding machine 1, and a display 15 configured to display information of the injection molding process. In some embodiments of the present disclosure, the controller 14 and the computing device 13 implement a controlling module of the injection molding system 1.

As shown in FIG. 1B, in some embodiments of the present disclosure, composites fed by the screw-driving motor 116 may be composite molding resin 9 which may include a polymeric material. The composite molding resin 9 may have a plurality of non-cylindrical fibers 90, wherein the non-cylindrical fibers 90 are all of the same shape. In some embodiments, the cross-sectional shape of one non-cylindrical fiber 90 may be similar to a shape of rectangle. The polymeric material is PP (Polypropylene), PBT (Polybutylene terephthalate), nylon or PC (Polycarbonate), and a fiber concentration of the non-cylindrical fibers 90 in the polymeric material is between 40 wt % and 60 wt %.

It should first be noted that, for a normal cylindrical fiber, a fiber orientation may be described by a unit vector of the cylindrical fiber, where the unit vector is along an axis of the cylindrical fiber. For concisely representing the fiber orientation of the cylindrical fiber, a second-order orientation tensor (refer to Advani SG, Tucker III CL, The use of tensors to describe and predict fiber orientation in short fiber composites, J Rheol 1987; 31(8) 751-784) is provided as:

$$A = ∮ Ψ ( p ) pp dp = [ \begin{matrix}{A}_{11} & {A}_{12} & {A}_{13} \\ {A}_{21} & {A}_{22} & {A}_{23} \\ {A}_{31} & {A}_{23} & {A}_{33}\end{matrix} ]$$

where p is the unit vector that is along the axis of the cylindrical fiber; Ψ(p) is a probability density distribution function over the orientation space; and A is a symmetric matrix with a trace of A₁₁+A₂₂+A₃₃=1. Physically, A=I/3 represents an isotropic state where I is an identity matrix. Three diagonal components A₁₁, A₇₂ and A₃₃ correspond to flow direction, cross-flow direction and thickness direction respectively.

For a non-cylindrical fiber, because a deformation ratio of the non-cylindrical fiber (e.g., a flatness ratio of a flat fiber) may affect fiber orientation, an additional cross-section vector, which is perpendicular to a unit vector of the non-cylindrical fiber, may be introduced for describing another fiber orientation where the unit vector is along an axis of the non-cylindrical fiber. Similar to the definition of the second-order orientation tensor, a cross-section orientation tensor Q for representing the another fiber orientation of the non-cylindrical fiber may be considered as:

$$Q = ∮ Ψ ( q ) qqdq = [ \begin{matrix}{B}_{11} & {B}_{12} & {B}_{13} \\ {B}_{21} & {B}_{22} & {B}_{23} \\ {B}_{31} & {B}_{23} & {B}_{33}\end{matrix} ]$$

where q is the cross-section vector that is perpendicular to the unit vector of the non-cylindrical fiber.

Unlike the unit vector and the second-order orientation tensor, however, there is to date no theoretical model for describing motion of the cross-section vector or the cross-section orientation tensor of the non-cylindrical fiber. Even the well-known theoretical calculation models (e.g., Mori-Tanaka model and Halpin-Tsai model) of micro-mechanical properties for fiber composites do not consider the cross-section vector related to the deformation ratio (e.g., the flatness ratio of the flat fiber) since such cross-section vector and the corresponding cross-section orientation tensor of the non-cylindrical fiber are very difficult to be modeled. Accordingly, alternative solutions are provided in the present disclosure.

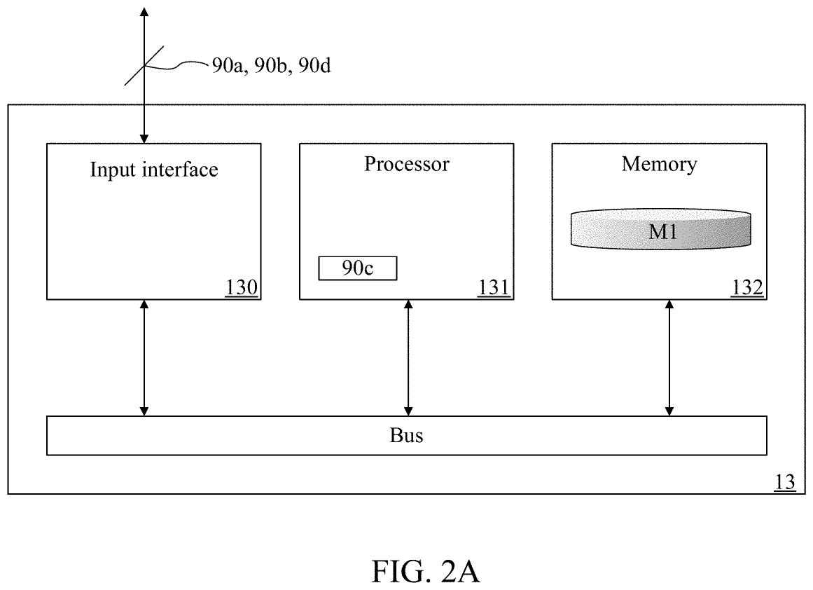

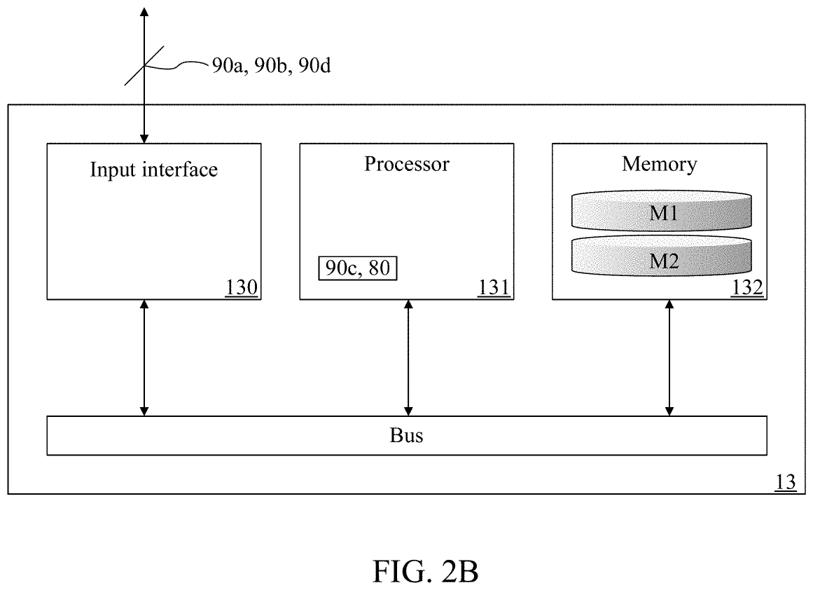

In some embodiments, before using the non-cylindrical fibers 90 in the composite molding resin 9 to form an injection molding object, data for fiber orientation distribution may be modeled first. Please refer to FIG. 2A, which is a block diagram of the computing device 13 in accordance with various embodiments of the present disclosure. The computing device 13 includes an input interface 130, a processor 131 and a memory 132. The memory 132 stores an orientation distribution generation model M1. The input device 130, the processor 131 and the memory 132 are electrically connected (e.g., electrically connected via bus), and the interactions therebetween will be further described hereinafter.

It should be noted first that, recently, an objective model of fiber orientation was developed in the field of suspension rheology, namely, iARD-RPR (Improved Anisotropic Rotary Diffusion and Retarding Principal Rate). The state-of-the-art predictive engineering tools of injection molding simulations, such as the Moldex3D (CoreTech System Co. of Taiwan), have incorporated the iARD-RPR model to provide predictions of fiber orientation.

In detail, the inventor of the present disclosure proposed an iARD-RPR model including three parts (See, U.S. Pat. No. 8,571,828; H.-C. Tseng, R.-Y. Chang, C.-H. Hsu, Phenomenological improvements to predictive models of fiber orientation in concentrated suspensions, J. Rheol., 57 (2013) 1597; H.-C. Tseng, R.-Y. Chang, C.-H. Hsu, An objective tensor to predict anisotropic fiber orientation in concentrated suspensions, J. Rheol., 60 (2016) 215; the entirety of which are incorporated herein by reference).

First, the iARD-RPR equation contains three terms: the Jeffery Hydrodynamics (HD) \dot{A}^{HD}, the iARD \dot{A}^{iARD}, and the RPR \dot{A}^{RPR}, presented as follows:

\dot{A}=\dot{A}^{HD}+\dot{A}^{iARD}(C_{I},C_{M})+\dot{A}^{RPR}(α) (1)

\dot{A}^{HD}=(W·A−A·W)+ξ(D·A+A·D−2A₄:D) (2)

where A is the second-order orientation tensor, representing the orientation distribution of the fibers; a time-evolution equation of the second-order orientation tensor \dot{A} is fixed on the material derivative; A₄ is a fourth-order orientation tensor; W=½(L−L^{T}) is the vorticity tensor and D=½(L+L^{T}) is the rate-of-deformation tensor; and L=∇v=W+D is the velocity gradient tensor with its component of Lᵢⱼ=Vⱼuᵢ, wherein uᵢ is the component of the velocity in the xᵢ direction. The superscript T is the transpose operator of a matrix throughout this paper; \dot{γ} is the shear rate of D, \dot{γ}=\sqrt{2D:D}. ξ=(aᵣ²−1)/(aᵣ²+1) is the shape factor, and aᵣ is the fiber aspect ratio, i.e., the ratio of fiber length l to fiber diameter d, aᵣ=l/d.

\dot{A}^{iARD}(C_{I},C_{M}) has two parameters: the fiber-to-fiber interaction parameter C_{I} and the fiber-to-matrix (fiber-to-polymer) interaction parameter C_{M}; \dot{A}^{RPR}(α) has one parameter α, which is meant to slow down a quicker response rate of the fiber movement.

Second, it is significant that the rotary diffusion tensor Dᵣ depends on the square of the objective rate-of-deformation tensor for defining a new iARD model, as below:

$${\dot{A}}^{iARD} = \dot{γ} [ 2 {D}_{r} - 2 tr ( {D}_{r} ) A - 5 {D}_{r} \cdot A - 5 A \cdot {D}_{r} + 10 {A}_{4} : {D}_{r} ] \\ {D}_{r} = {C}_{I} ( I - {C}_{M} \frac{{D}^{2}}{‖ {D}^{2} ‖} ) \qquad ( 3 )$$

where D is the rate-of-deformation tensor, which is the symmetric part of the velocity-gradient tensor L, D=½(L^{T}+L). The scalar

$$‖ {D}^{2} ‖ = \sqrt{\frac{1}{2} {D}^{2} : {D}^{2}}$$

is the norm of tensor D². In particular, the rotary diffusion tensor Dᵣ depends on the fiber to matrix (fiber-to-polymer) interaction parameter C_{M}, and is independent of the fiber's orientation distribution A.

Lastly, the RPR model is introduced as follows:

\dot{A}^{RPR}=−R·\dot{Λ}^{IOK}·R^{T} (4)

\dot{A}ᵢᵢ^{IOK}=α\dot{λ}ᵢ,i,j,k=1,2,3 (5)

where \dot{Λ}^{IOK} is the material derivative of a particular diagonal tensor and its superscript indicates the intrinsic orientation kinetics (IOK) assumption (see, Tseng, H.-C., R.-Y. Chang, and C.-H. Hsu, “Method and Computer Readable Media for Determining Orientation of Fibers in a Fluid,” U.S. Pat. No. 8,571,828 (2013) and Tseng, H.-C., R.-Y. Chang, and C.-H. Hsu, “Phenomenological Improvements to Predictive Models of Fiber Orientation in Concentrated Suspensions” J Rheol 57 1597-1631 (2013); the entirety of which is incorporated herein by reference); R is the rotation matrix and R^{T} is the transpose of R; the superscript T is the transpose operator of a matrix throughout this paper; λᵢ is the eigenvalues of A, λ₁≥Δ₂≥λ₃; and R=[e₁,e₂,e₃] is defined by eigenvector columns of A. This rotation matrix is also an orthogonal matrix, R·R^{T}=R^{T}·R=I, where I is the identity matrix.

Accordingly, the orientation distribution generation model M1 used based on the iARD-RAR model may be applied to aspect ratio and fiber data of fiber to generate corresponding fiber orientation distributions.

Accordingly, the input interface 130 receives geometry data 90a and fiber data 90b of one non-cylindrical fiber 90. The processor 131 calculates an aspect ratio 90c of the non-cylindrical fibers 90 based on the geometry data 90a, and inputs the aspect ratio 90c and the fiber data 90b into the orientation distribution generation model M for deriving a non-cylindrical fiber orientation distribution which matches a predetermined orientation distribution.

In some embodiments, before using the non-cylindrical fibers 90 in the composite molding resin 9 to form an injection molding object based on the derived non-cylindrical fiber orientation distribution, data for potential warpage may be modeled first. Please refer to FIG. 2B, which is a block diagram of the computing device 13 in accordance with various embodiments of the present disclosure. It should be noted that the memory 132 may further store a deformation model M2 which is applied to fiber orientation distribution and aspect ratio of fiber to generate corresponding warpage data of an injection molding object (refer to VE-Cross-WLF model of U.S. Pat. No. 8,768,662; the entirety of U.S. Pat. No. 8,768,662 is incorporated herein by reference).

Accordingly, when the non-cylindrical fiber orientation distribution matches the predetermined orientation distribution, the processor 131 inputs the non-cylindrical fiber orientation distribution and the aspect ratio 90c into the deformation model M2 for deriving warpage data 80 of an injection molding object (not shown).

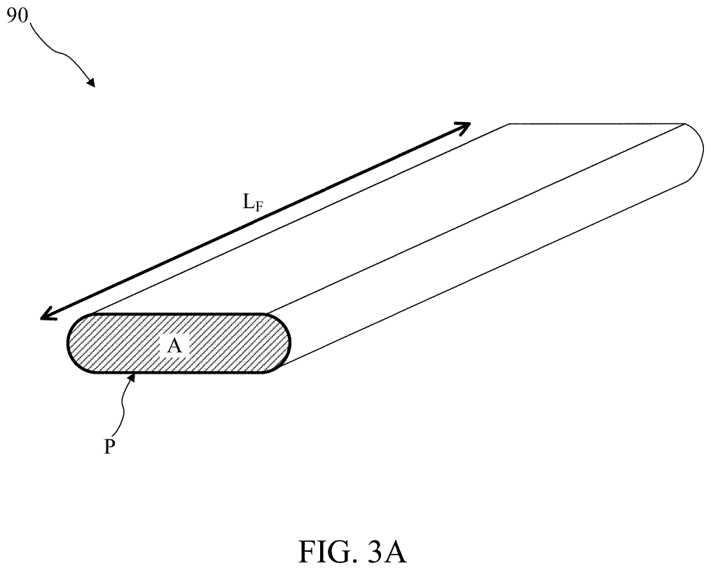

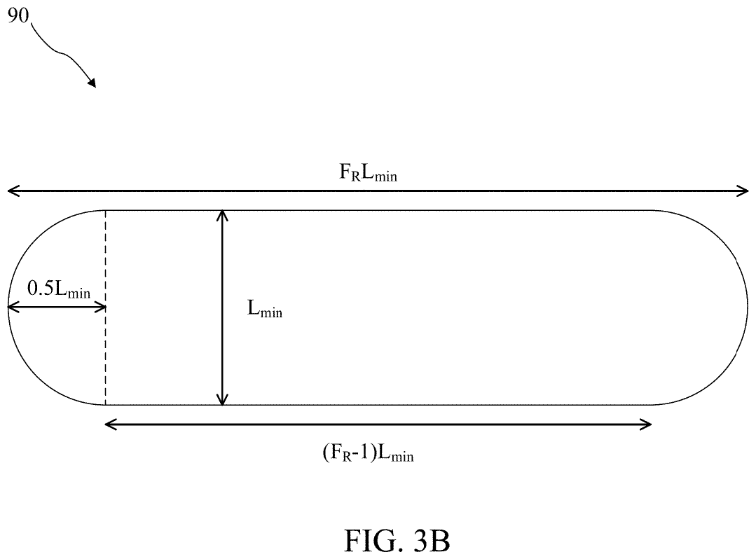

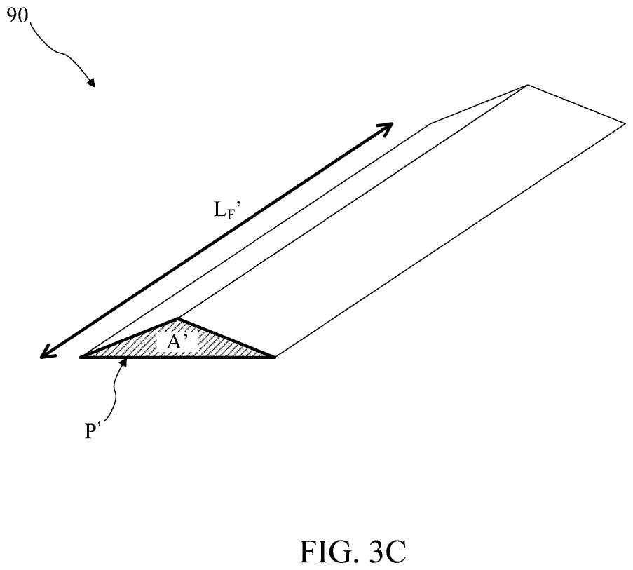

In some embodiments, the perspective view of the non-cylindrical fiber 90 is shown in FIG. 3A. The geometry data 90a includes a fiber length L_{F} of the non-cylindrical fiber 90, a cross-sectional area A of the non-cylindrical fiber 90 and a perimeter P of the cross-sectional area A of the non-cylindrical fiber 90. The aspect ratio 90c, which is represented as R, is derived based on the following formula:

$$R = \frac{{L}_{F}}{( \frac{4 \times A}{P} )}$$

Further, in some embodiments, the cross-sectional area A of the non-cylindrical fiber 90 is shown in FIG. 3B. A width of the non-cylindrical fiber 90 is Lₘᵢₙ and a flatness ratio of the non-cylindrical fiber 90 is F_{R}. Accordingly, while the shape of the non-cylindrical fiber 90 includes a half circle at each of two ends respectively and the diameter of the half circle is equal to the width of the non-cylindrical fiber 90, Dₑ, which represents

$$\frac{( 4 \times A )}{P} ,$$

may be derived as the following formula:

$${D}_{e} = \frac{π + 4 \times ( {F}_{R} - 1 )}{π + 2 \times ( {F}_{R} - 1 )} {L}_{m i n}$$

In some embodiments, the perspective view of the non-cylindrical fiber 90 is shown in FIG. 3C. The geometry data 90a includes a fiber length L_{F}′ of the non-cylindrical fiber 90, a cross-sectional area A′ of the non-cylindrical fiber 90 and a perimeter P′ of the cross-sectional area A′ of the non-cylindrical fiber 90. The aspect ratio 90c, which is represented as R′, is derived based on the following formula:

$${R}^{′} = \frac{{L}_{{F}^{′}}}{( \frac{4 \times {A}^{′}}{{P}^{′}} )}$$

In some embodiments, the fiber data 90c includes a fiber-to-fiber interaction parameter that relates to the parameter C_{I} of the iARD-RAR model, a fiber-to-polymer interaction parameter that relates to the parameter C_{M} of the iARD-RAR model, and a fiber slow-down rate parameter that relates to the parameter α of the iARD-RAR model. Therefore, after applying the orientation distribution generation model M1, which is used based on the iARD-RAR model, to the aspect ratio 90c and the fiber data 90b of the present disclosure, fiber orientation distributions related to components A₁₁ and A₂₂ of the second-order orientation tensor may be obtained.

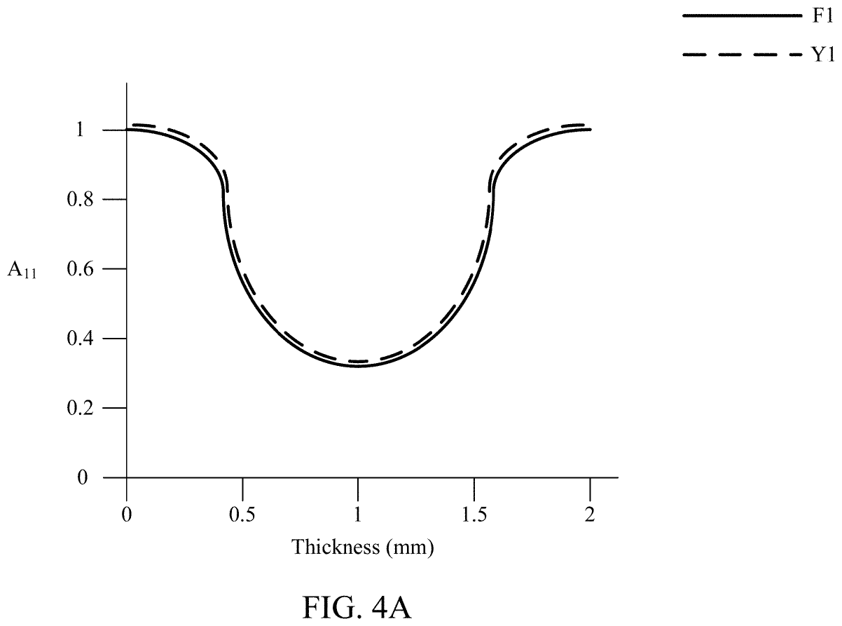

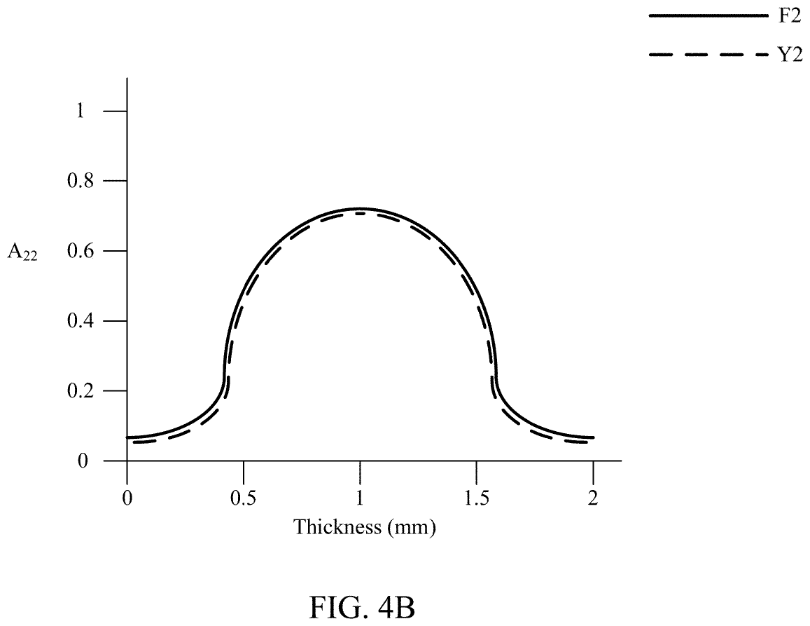

In some embodiments, the non-cylindrical fiber orientation distribution may be a flow direction orientation distribution F1, which relates to component A₁₁ of the second-order orientation tensor. Please refer to FIG. 4A, which is a graph of the flow direction orientation distribution F1 and a predetermined orientation distribution Y1 against a thickness of the injection molding object in accordance with an embodiment of the present disclosure. In this embodiment, the flow direction orientation distribution F is obtained by inputting the aspect ratio 90c and the fiber data 90b into the orientation distribution generation model M1.

In some embodiments, the non-cylindrical fiber orientation distribution may be a cross-flow direction orientation distribution F2, which relates to component A₂₂ of the second-order orientation tensor. Please refer FIG. 4B, which is a graph of the cross-flow direction orientation distribution F2 and a predetermined orientation distribution Y2 against a thickness of the injection molding object in accordance with an embodiment of the present disclosure. In this embodiment, the flow direction orientation distribution F2 is obtained by inputting the aspect ratio 90c and the fiber data 90b into the orientation distribution generation model M1.

It should be noted that the predetermined orientation distributions Y1 and Y2 may be defined directly based on the physical properties of the non-cylindrical fiber 90. In some embodiments, the predetermined orientation distributions Y1 and Y2 may be defined based on orientation distributions of a cylindrical fiber.

In detail, based on a general shell-core structure of a flow direction fiber orientation distribution, the fibers show high orientation along the flow direction in the shell layer. In the core region, most of the fibers are oriented perpendicular to the flow direction. Significantly, due to the physical properties of non-cylindrical fibers, the cross-flow-directional orientation tensor components A₂₂, which are related to non-cylindrical fibers, in the core region may be enhanced. Thus, at a specific thickness, the component A₂₂ related to a non-cylindrical fiber may be greater than the component A₂₂ related to a general cylindrical fiber. Consequently, at a specific thickness, the component A₁₁ related to a non-cylindrical fiber may be less than the component A₁₁ related to a general cylindrical fiber.

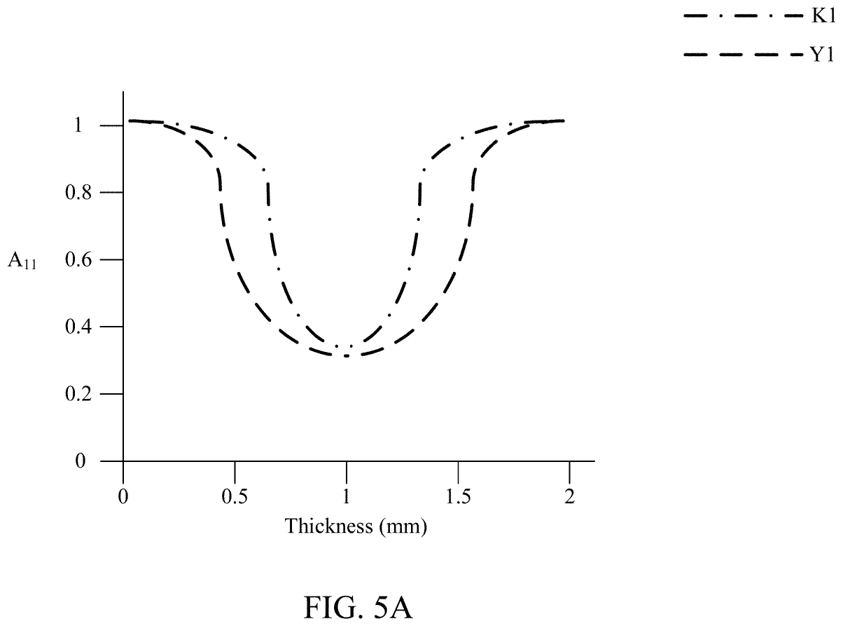

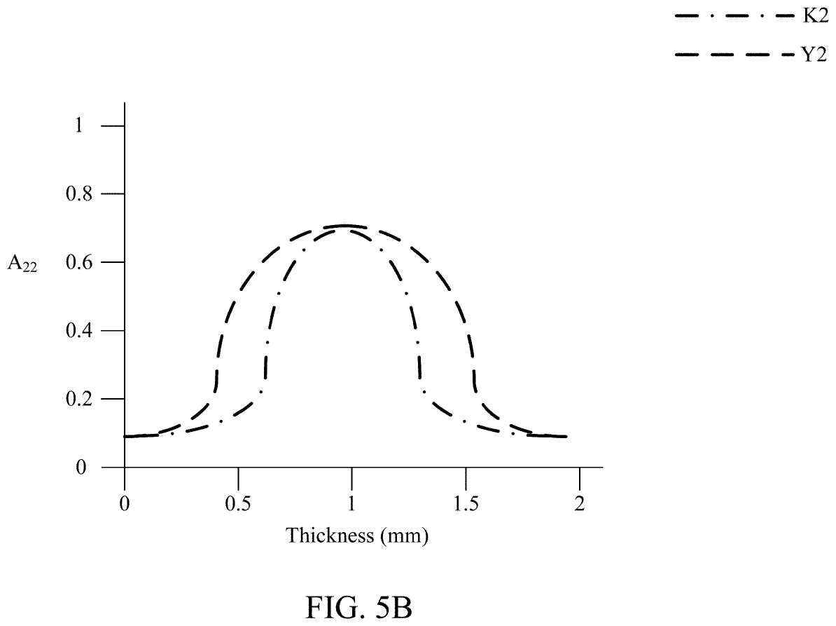

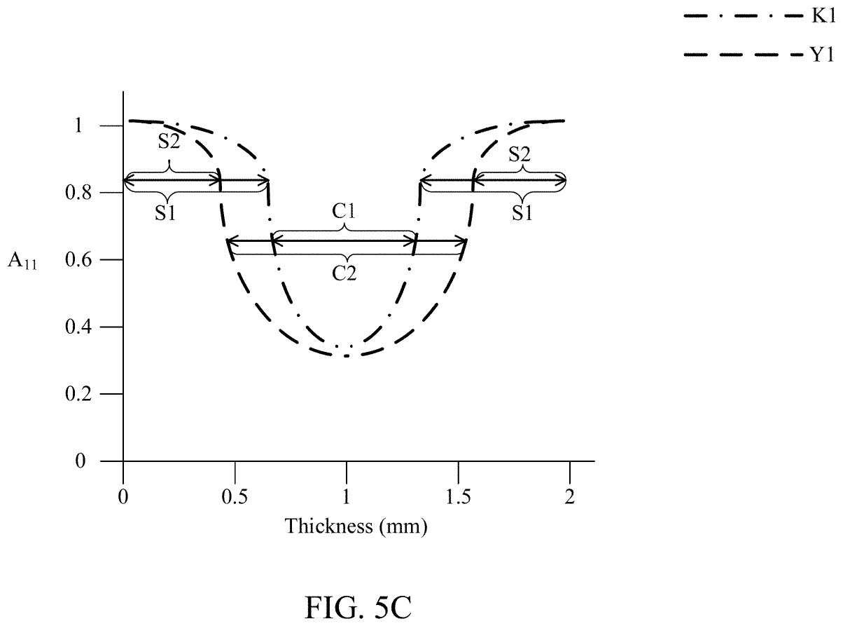

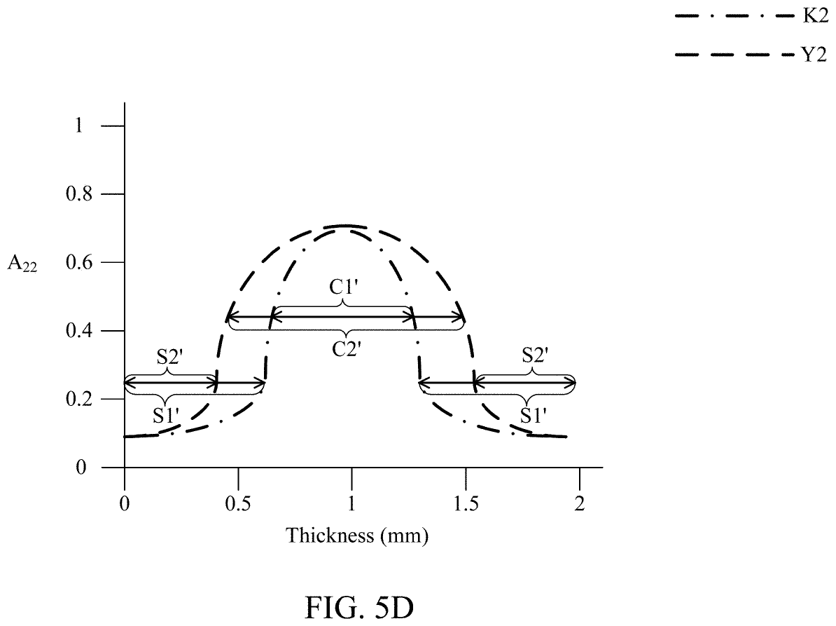

Please refer to FIG. 5A. FIG. 5A is a graph of the predetermined orientation distribution Y1 and a cylindrical fiber orientation distribution K1 while they are flow direction orientation distributions. In some embodiments, the cylindrical fiber orientation distribution K1 is obtained by inputting aspect ratio and fiber data of a cylindrical fiber into the orientation distribution generation model M1. Next, the predetermined orientation distribution Y1 may be defined based on a rule that orientation tensor components of the predetermined orientation distribution Y1 are less than or equal to orientation tensor components of the cylindrical fiber orientation distribution K1 at different thickness.

For example, at thickness t (t from 0 mm to 2 mm), an orientation tensor component A₁₁ of the predetermined orientation distribution Y1 is set less than or equal to an orientation tensor component A₁₁ of the cylindrical fiber orientation distribution K1. Accordingly, the predetermined orientation distribution Y1 is formed as shown in FIG. 5A.

Please refer to FIG. 5B. FIG. 5B is a schematic view of the predetermined orientation distribution Y2 and a cylindrical fiber orientation distribution K2 while they are cross-flow direction orientation distributions. In some embodiments, the cylindrical fiber orientation distribution K2 is obtained by inputting aspect ratio and fiber data of a cylindrical fiber into the orientation distribution generation model M1. Next, the predetermined orientation distribution Y2 may be defined based on a rule that orientation tensor components of the predetermined orientation distribution Y2 are greater than or equal to orientation tensor components of the cylindrical fiber orientation distribution K2 at different thickness.

For example, at thickness t (t from 0 mm to 2 mm), an orientation tensor component A₂₂ of the predetermined orientation distribution Y2 is set greater than or equal to an orientation tensor component A₂₂ of the cylindrical fiber orientation distribution K2. Accordingly, the predetermined orientation distribution Y2 is formed as shown in FIG. 5B.

In some embodiments, the non-cylindrical fiber orientation distributions F1 and F2 may directly match the predetermined orientation distributions Y1 and Y2, respectively, with the aspect ratio 90c and the non-cylindrical fiber data 90c. However, in some embodiments, the non-cylindrical fiber orientation distributions F1 and F2 may not match the predetermined orientation distributions Y1 and Y2, respectively, with the aspect ratio 90c and the non-cylindrical fiber data 90c. Accordingly, non-cylindrical fiber data 90d, which is different from the non-cylindrical fiber data 90c, is selected by the computing device 13, and the processor 131 inputs the aspect ratio 90c and the fiber data 90d into the orientation distribution generation model M1 for updating the non-cylindrical fiber orientation distributions F1 and F2. The operations of selecting fiber data and updating the non-cylindrical fiber orientation distributions F1 and F2 may be repeated until the non-cylindrical fiber orientation distributions F1 and F2 match the predetermined orientation distributions Y1 and Y2, respectively.

In some embodiments, the selection of the fiber data may be performed based on the aspect of the shell-core structure for the fiber orientation distributions. It should be noted first that, as for the shell-core structure, micro-computer tomography, which is a non-destructive testing method, may be introduced to obtain the digital data of fiber orientation tensor components as a function of the layer thickness. The orientation tensor components include at least the flow-direction orientation tensor component A₁₁ and the cross-flow-direction orientation component A₂₂. The shell layers and the core region of the fiber orientation distribution for the FRT composite article include at least two significant features: (i) in the shell layers, both A₁₁ and A₂₂ curves are almost parallel with higher A₁₁ values and lower A₂₂ values; and (ii) over the core region, the A₁₁ and A₂₂ curves obviously cross, with lower A₁₁ values and higher A₂₂ values.

Please refer to FIG. 5C which is a graph of the predetermined orientation distribution Y1 and the cylindrical fiber orientation distribution K1 based on the aspect of the shell-core structure. In some embodiments, a shell layer is defined as the area (near the cavity wall) with the flow-directional orientation tensor components A₁₁ which are greater than a first threshold and a core region is defined as the area (near the cavity center) with the flow-directional orientation tensor components A₁₁ which are less than a second threshold.

Accordingly, as for the cylindrical fiber orientation distribution K1, a width of shell layer may be defined as S1 and a width of core region may be defined as C1. As for the predetermined orientation distribution Y1 related to the non-cylindrical fibers 90, since the flow-directional orientation tensor components A₁₁ related to the non-cylindrical fibers 90 may be reduced due to the physical properties of non-cylindrical fiber, a width S2 of shell layer related to the predetermined orientation distribution Y may decrease consequently. In other words, the width S2 of shell layer related to the predetermined orientation distribution Y1 may be thinner than the width S1 of shell layer related to the cylindrical fiber orientation distribution K1.

On the other hand, a width C2 of core region related to the predetermined orientation distribution Y1 may increase, and may be thicker than the width C1 of core region related to the cylindrical fiber orientation distribution K1. Accordingly, when the selection of the fiber data for the predetermined orientation distribution Y1 is performed, the parameters C_{I} and C_{M} related to the shell layer and the parameter α related to the core region may be considered for adjusting the predetermined orientation distribution Y1.

Please refer to FIG. 5D which is a graph of the predetermined orientation distribution Y2 and the cylindrical fiber orientation distribution K2 based on the aspect of the shell-core structure. In some embodiments, a shell layer is defined as the area (near the cavity wall) with the cross-flow-directional orientation tensor components A₂₂ which are less than a third threshold and a core region is defined as the area (near the cavity center) with the cross-flow-directional orientation tensor components A₂₂ which are greater than a fourth threshold.

Accordingly, as for the cylindrical fiber orientation distribution K2, a width of shell layer may be defined as S1′ and a width of core region may be defined as C1′. As for the predetermined orientation distribution Y2 related to the non-cylindrical fibers 90, since the cross-flow-directional orientation tensor components A₂₂ related to the non-cylindrical fibers 90 may be enhanced due to the physical properties of non-cylindrical fiber, a width C2′ of core region related to the predetermined orientation distribution Y2 may increase consequently. In other words, the width C2′ of core region related to the predetermined orientation distribution Y2 may be thicker than the width C1′ of the core region related to the cylindrical fiber orientation distribution K2.

On the other hand, a width S2′ of shell layer related to the predetermined orientation distribution Y2 may reduce, and the width S2′ of shell layer related to the predetermined orientation distribution Y1 may be thinner than the width S1′ of shell layer related to the cylindrical fiber orientation distribution K2. Accordingly, when the selection of the fiber data for the predetermined orientation distribution Y2 is performed, the parameters C_{I} and C_{M} related to the shell layer and the parameter α related to the core region may be reconsidered for adjusting the predetermined orientation distribution Y2.

In some embodiments, after the non-cylindrical fiber orientation distributions F1 and F2 match the predetermined orientation distribution Y1 and Y2, the processor 131 inputs the aspect ratio 90c and the non-cylindrical fiber orientation distributions F1 and F2 with the corresponding fiber data (e.g., fiber data 90c or 90d) into the deformation model M2 for deriving warpage data of the injection molding object.

Please refer back to FIG. 1B. In some embodiments, after obtaining the non-cylindrical fiber orientation distribution of the injection molding object, the controller 14 is configured to control the molding machine 11 to perform an actual molding for injecting the composite molding resin 9 having the non-cylindrical fibers 90 into at least a portion of the mold cavity 120 based on the non-cylindrical fiber orientation distribution. In some embodiments of the present disclosure, after obtaining the warpage data of the injection molding object, the controller 14 is configured to control the molding machine 11 to perform an actual molding for injecting the composite molding resin 9 having the non-cylindrical fibers 90 into at least a portion of the mold cavity 120 based on the non-cylindrical fiber orientation distribution and the warpage data.

In some embodiments, the non-cylindrical fibers 90 may be flat fibers. Based on the above description of the present disclosure, when geometry data and fiber data of one flat fiber are obtained, an aspect ratio of the flat fiber can be calculated. Further, the aspect ratio and the fiber data can be inputted into the orientation distribution generation model M1 for deriving a flat fiber orientation distribution. When the flat fiber orientation distribution matches a predetermined orientation distribution, the flat fiber orientation distribution and the aspect ratio of the flat fiber can be inputted into the deformation model M2 for deriving warpage data of an injection molding object.

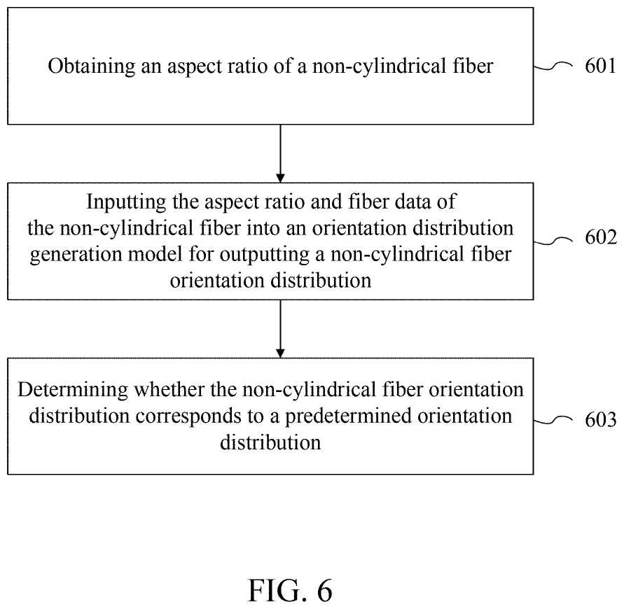

FIG. 6 is a flowchart showing a method for modeling fiber orientation distribution related to an injection molding object in accordance with some embodiments of the present disclosure. The method of some embodiments may be executed by a computing device of an injection molding system (e.g., the computing device and the injection molding system of the aforesaid embodiments). Detailed operations of the method are as follows.

First, operation 601 is executed to obtain an aspect ratio of a non-cylindrical fiber. Operation 602 is executed to input the aspect ratio and fiber data of the non-cylindrical fiber into an orientation distribution generation model for outputting a non-cylindrical fiber orientation distribution. Operation 603 is executed to determine whether the non-cylindrical fiber orientation distribution corresponds to a predetermined orientation distribution.

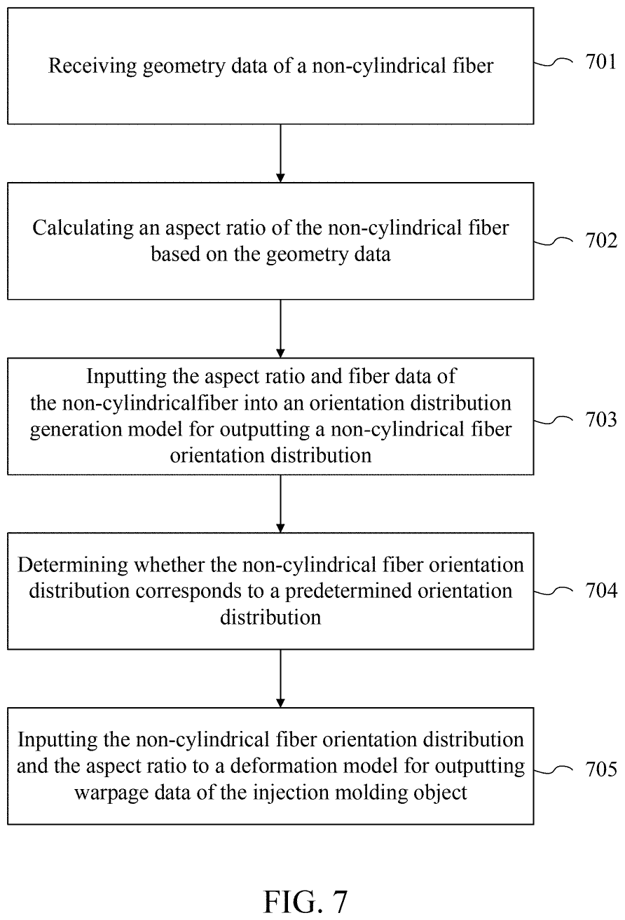

FIG. 7 is a flowchart showing a method for modeling fiber orientation distribution related to an injection molding object in accordance with some embodiments of the present disclosure. The method of some embodiments may be executed by a computing device of an injection molding system (e.g., the computing device and the injection molding system of the aforesaid embodiments). Detailed operations of the method are as follows.

First, operation 701 is executed to receive geometry data of a non-cylindrical fiber. Operation 702 is executed to calculate an aspect ratio of the non-cylindrical fiber based on the geometry data. In some embodiments, the geometry data further includes a fiber length of the non-cylindrical fiber, a cross-sectional area of the non-cylindrical fiber and a perimeter of a cross section of the non-cylindrical fiber. The aspect ratio is derived based on the following formula:

$$R = \frac{{L}_{F}}{( \frac{4 \times A}{P} )}$$

where R represents the aspect ratio, L_{F} represents the fiber length, A represents the cross-sectional area and P represents the perimeter.

Operation 703 is executed to input the aspect ratio and fiber data of the non-cylindrical fiber into an orientation distribution generation model for outputting a non-cylindrical fiber orientation distribution. In some embodiments, the fiber data includes a fiber-to-fiber interaction parameter, a fiber-to-polymer interaction parameter and a fiber slow-down rate parameter.

Operation 704 is executed to determine whether the non-cylindrical fiber orientation distribution corresponds to a predetermined orientation distribution. In some embodiments, the predetermined orientation distribution is established according to a cylindrical fiber orientation distribution.

In some embodiments, while the predetermined orientation distribution and the cylindrical fiber orientation distribution relate to flow direction orientation distributions, the predetermined orientation distribution is established based on a rule that orientation tensor components of the flow direction orientation distribution of the predetermined orientation distribution are less than or equal to orientation tensor components of the flow direction orientation distribution of the cylindrical fiber orientation distribution at different thicknesses.

In some embodiments, while the predetermined orientation distribution and the cylindrical fiber orientation distribution relate to cross-flow direction orientation distributions, the predetermined orientation distribution is established based on a rule that orientation tensor components of the flow direction orientation distribution of the predetermined orientation distribution are greater than or equal to orientation tensor components of the flow direction orientation distribution of the cylindrical fiber orientation distribution at different thicknesses.

Operation 705 is optionally executed to input the non-cylindrical fiber orientation distribution and the aspect ratio to a deformation model for outputting warpage data of the injection molding object.

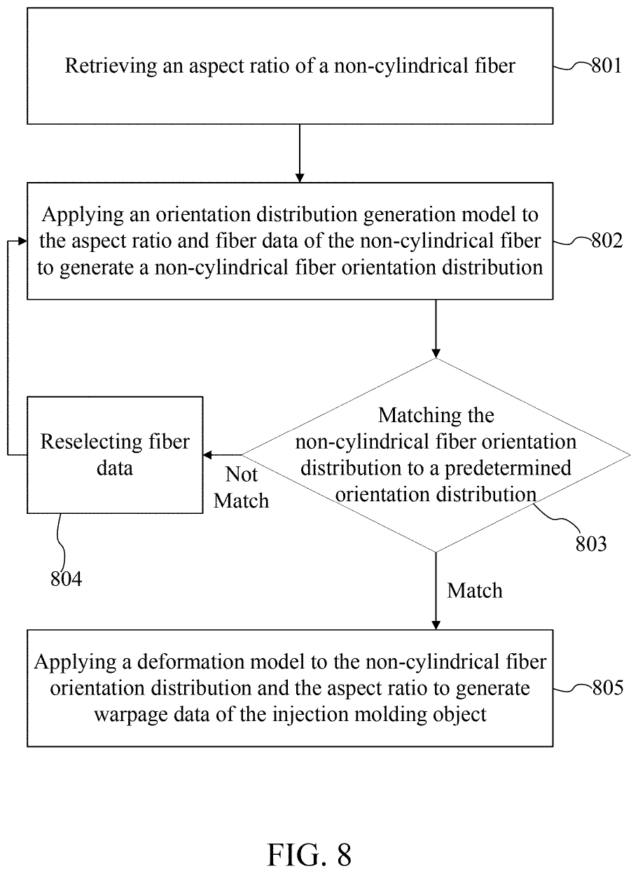

FIG. 8 is a flowchart showing a method for modeling fiber orientation distribution related to an injection molding object in accordance with some embodiments of the present disclosure. The method of some embodiments may be executed by a computing device of an injection molding system (e.g., the computing device and the injection molding system of the aforesaid embodiments). Detailed operations of the method are as follows.

First, operation 801 is executed to retrieve an aspect ratio of a non-cylindrical fiber. Operation 802 is executed to apply an orientation distribution generation model to the aspect ratio and fiber data of the non-cylindrical fiber to generate a non-cylindrical fiber orientation distribution. Operation 803 is executed to match the non-cylindrical fiber orientation distribution to a predetermined orientation distribution.

If the non-cylindrical fiber orientation distribution does not match the predetermined orientation distribution, operation 804 is executed to reselect fiber data, and operation 802 is executed to update the non-cylindrical fiber orientation distribution.

If the non-cylindrical fiber orientation distribution matches the predetermined orientation distribution, the non-cylindrical fiber orientation distribution and the corresponding fiber data may be used as the factors for injection molding by the composites with the non-cylindrical fiber. Operation 805 is optionally executed to apply a deformation model to the non-cylindrical fiber orientation distribution and the aspect ratio to generate warpage data of the injection molding object.

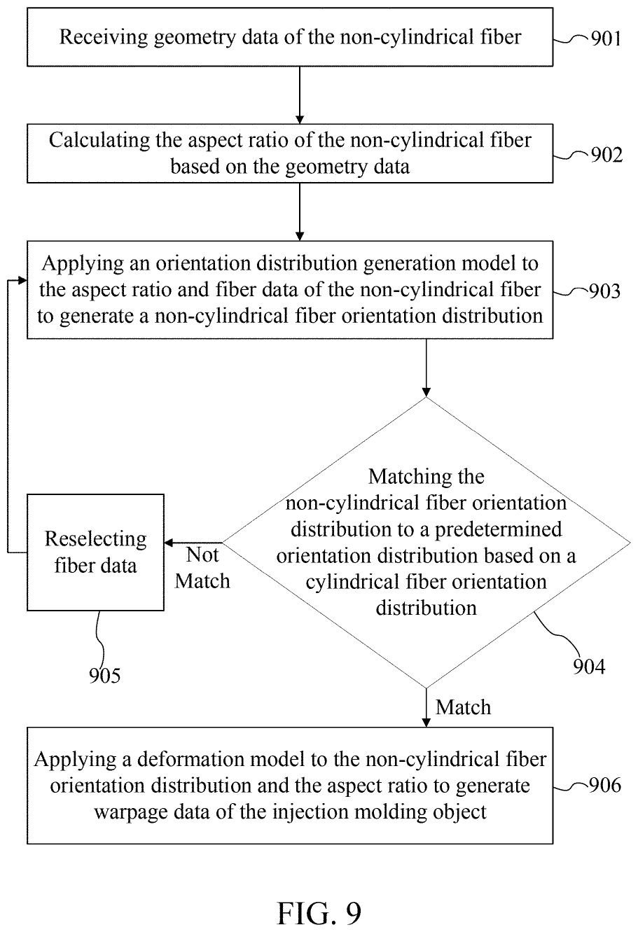

FIG. 9 is a flowchart showing a method for modeling fiber orientation distribution related to an injection molding object in accordance with some embodiments of the present disclosure. The method of some embodiments may be executed by a computing device of an injection molding system (e.g., the computing device and the injection molding system of the aforesaid embodiments). Detailed operations of the method are as follows.

First, operation 901 is executed to receive geometry data of the non-cylindrical fiber. Operation 902 is executed to calculate the aspect ratio of the non-cylindrical fiber based on the geometry data. In some embodiments, the geometry data further includes a fiber length of the non-cylindrical fiber, a cross-sectional area of the non-cylindrical fiber and a perimeter of a cross section of the non-cylindrical fiber. The aspect ratio is derived based on the following formula:

$$R = \frac{{L}_{F}}{( \frac{4 \times A}{P} )}$$

where R represents the aspect ratio, L_{F} represents the fiber length, A represents the cross-sectional area and P represents the perimeter.

Operation 903 is executed to apply an orientation distribution generation model to the aspect ratio and fiber data of the non-cylindrical fiber to generate a non-cylindrical fiber orientation distribution. In some embodiments, the fiber data includes a fiber-to-fiber interaction parameter, a fiber-to-polymer interaction parameter, and a fiber slow-down rate parameter.

Operation 904 is executed to match the non-cylindrical fiber orientation distribution to a predetermined orientation distribution based on a cylindrical fiber orientation distribution.

In some embodiments, while the predetermined orientation distribution and the cylindrical fiber orientation distribution relate to flow direction orientation distributions, the predetermined orientation distribution is established based on a rule that orientation tensor components of the flow direction orientation distribution of the predetermined orientation distribution are less than or equal to orientation tensor components of the flow direction orientation distribution of the cylindrical fiber orientation distribution at different thicknesses.

In some embodiments, while the predetermined orientation distribution and the cylindrical fiber orientation distribution relate to cross-flow direction orientation distributions, the predetermined orientation distribution is established based on a rule that orientation tensor components of the flow direction orientation distribution of the predetermined orientation distribution are greater than or equal to orientation tensor components of the flow direction orientation distribution of the cylindrical fiber orientation distribution at different thicknesses.

If the non-cylindrical fiber orientation distribution does not match the predetermined orientation distribution, operation 905 is executed to reselect fiber data, and operation 903 is executed to update the non-cylindrical fiber orientation distribution. In some embodiments, the reselected fiber data includes a fiber-to-fiber interaction parameter, a fiber-to-polymer interaction parameter and a fiber slow-down rate parameter.

If the non-cylindrical fiber orientation distribution matches the predetermined orientation distribution, the non-cylindrical fiber orientation distribution and the corresponding fiber data may be used as the factors for injection molding by the composites with the non-cylindrical fiber. Operation 906 is optionally executed to apply a deformation model to the non-cylindrical fiber orientation distribution and the aspect ratio to generate warpage data of the injection molding object.

In some embodiments, the non-cylindrical fibers applied in the above operations may be flat fibers. Based on the above description of the present disclosure, when geometry data and fiber data of one flat fiber are obtained, an aspect ratio of the flat fiber can be calculated. Further, the aspect ratio and the fiber data can be inputted into the orientation distribution generation model for deriving a flat fiber orientation distribution. When the flat fiber orientation distribution matches a predetermined orientation distribution, the flat fiber orientation distribution and the aspect ratio of the flat fiber can be inputted into the deformation model for deriving warpage data of an injection molding object.

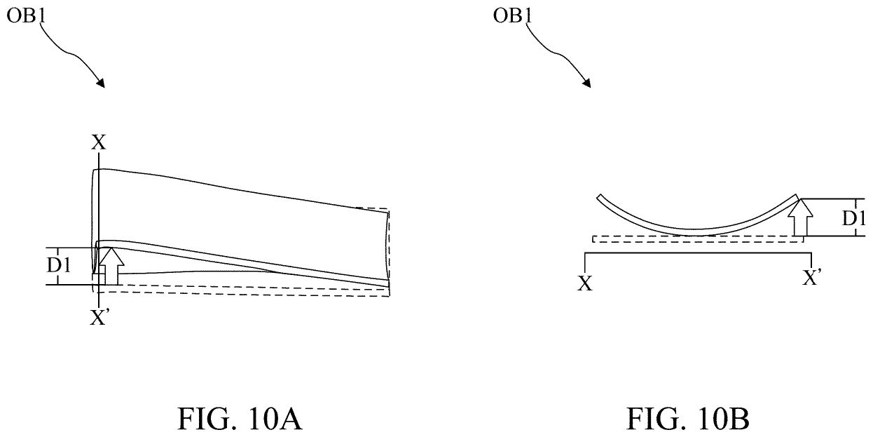

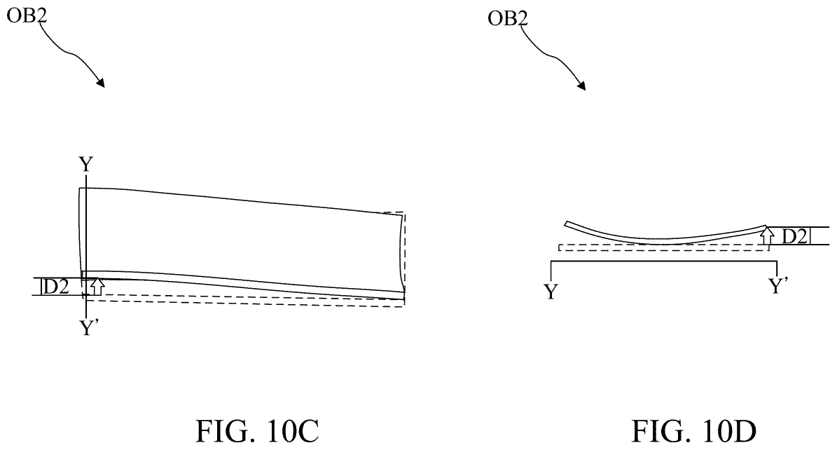

In some embodiments, the warpage data in the above embodiments may be used for representing the corresponding injection molding object by the CAE software (e.g., the abovementioned Moldex3D incorporating the iARD-RPR model). Please refer to FIGS. 10A to 10D. FIGS. 10A and 10C are schematic views of simulated injection molding objects OB1 and OB2 with warpage data generated based on different orientation distributions and aspect ratios via the CAE software in accordance with various embodiments of the present disclosure. FIGS. 10B and 10D are cross sections of the injection molding objects OB1 and OB2 in accordance with some embodiments of the present disclosure.

In detail, as shown in FIGS. 10A and 10C, when the warpage data is generated based on the orientation distributions and the aspect ratios corresponding to the cylindrical fibers, the CAE software illustrates the simulated injection molding object OB1 based on such warpage data. As shown in FIGS. 10B and 10D, when the warpage data is generated based on the orientation distributions and the aspect ratios corresponding to the non-cylindrical fibers (e.g., flat fibers), the CAE software illustrates the simulated injection molding object OB2 based on such warpage data. It should be noted that, in FIGS. 10A to 10D, the dotted lines represent an ideal injection molding object without deformation and the solid lines represent the injection molding objects OB1 and OB2 with deformations.

Referring to FIGS. 10A to 10D, it can be seen that the deformation (i.e., the deformation marked by an arrow with a displacement D2 in FIGS. 10C and 10D) of the injection molding object OB2 made of the composites with the non-cylindrical fibers is less than the deformation (i.e., the deformation marked by an arrow with a displacement D1 in FIGS. 10A and 10B) of the injection molding object OB1 made of the composites with the cylindrical fibers. In some embodiments, the displacement D1 may be about 1.0 mm to 1.3 mm and the displacement D2 may be about 0.1 mm to 0.3 mm. Accordingly, the reduction of the deformation of the injection molding object made of the composites with the non-cylindrical fibers is verified by the simulations.

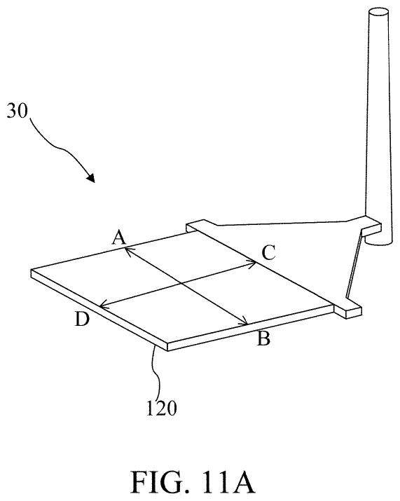

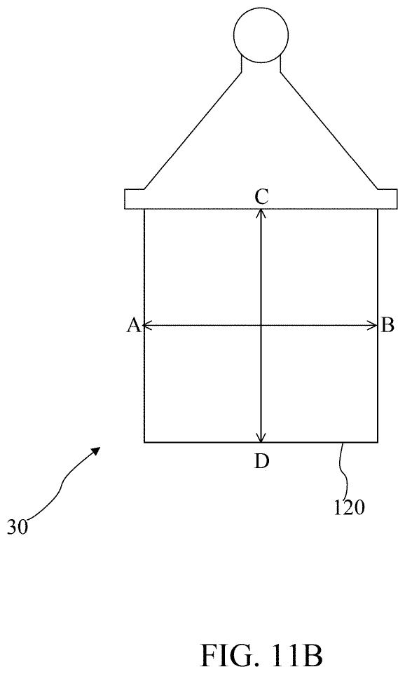

FIGS. 11A and 11B are schematic views of a genuine domain 30 of an injection molding object with a fan-gated plaque geometry in accordance with some embodiments of the present disclosure. Referring back to FIGS. 1A and 1B, the genuine domain 30 is an example of a vacant area of the mold cavity 120 of the mold 20. When the composites are fed into the mold cavity 120 for forming the injection molding object, the direction between A and B represents a cross-flow direction and the direction between C and D represents a flow direction.

In some embodiments, shrinkage of the injection molding object occurs during the process of forming the injection molding object. In particular, when dimensions of an ideal injection molding object are about 80 mm length, 80 mm width and 2 mm thickness and the injection molding object is formed with the composites having the cylindrical fibers, the shrinkage occurring in the direction A-B (i.e., the cross-flow direction) may be about 1.2% to 1.35% and the shrinkage occurring in the direction C-D (i.e., the flow direction) may be about 0.12% to 0.14%.

In detail, when a desired length of the injection molding object along the direction A-B is L1 and an actual length of the injection molding object along the direction A-B is L2, the shrinkage percentage, which is

$$\frac{L 1 - L 2}{L 1} ,$$

of the direction A-B may be about 1.2% to 1.35%. Similarly, when a desired length of the injection molding object along the direction C-D is L1′ and an actual length of the injection molding object along the direction C-D is L2′, the shrinkage percentage, which is

$$\frac{L {1}^{′} - L {2}^{′}}{L {1}^{′}} ,$$

of the direction C-D may be about 0.12% to 0.14%.

When the dimension of the ideal injection molding object are about 80 mm length, 80 mm width and 2 mm thickness and the injection molding object is formed with the composites having the non-cylindrical fibers (e.g., flat fibers), the shrinkage occurring in the direction A-B (i.e., the cross-flow direction) may be about 0.7% to 0.74% and the shrinkage occurring in the direction C-D (i.e., the flow direction) may be about 0.09% to 0.1%.

In detail, when a desired length of the injection molding object along the direction A-B is L3 and an actual length of the injection molding object along the direction A-B is L4, the shrinkage percentage, which is

$$\frac{L 3 - L 4}{L 3} ,$$

of the direction A-B may be about 0.7% to 0.74%. Similarly, when a desired length of the injection molding object along the direction C-D is L3′ and an actual length of the injection molding object along the direction C-D is L4′, the shrinkage percentage, which is

$$\frac{L {3}^{′} - L {4}^{′}}{L {3}^{′}} ,$$

of the direction C-D may be about 0.09% to 0.1%.

Accordingly, it can be seen that, by replacing the cylindrical fibers with the non-cylindrical fibers in the composites for forming the injection molding object, the shrinkage of the cross-flow direction can be improved by about 42% to 45%, and the shrinkage of the flow direction can be improved by about 25% to 29%.

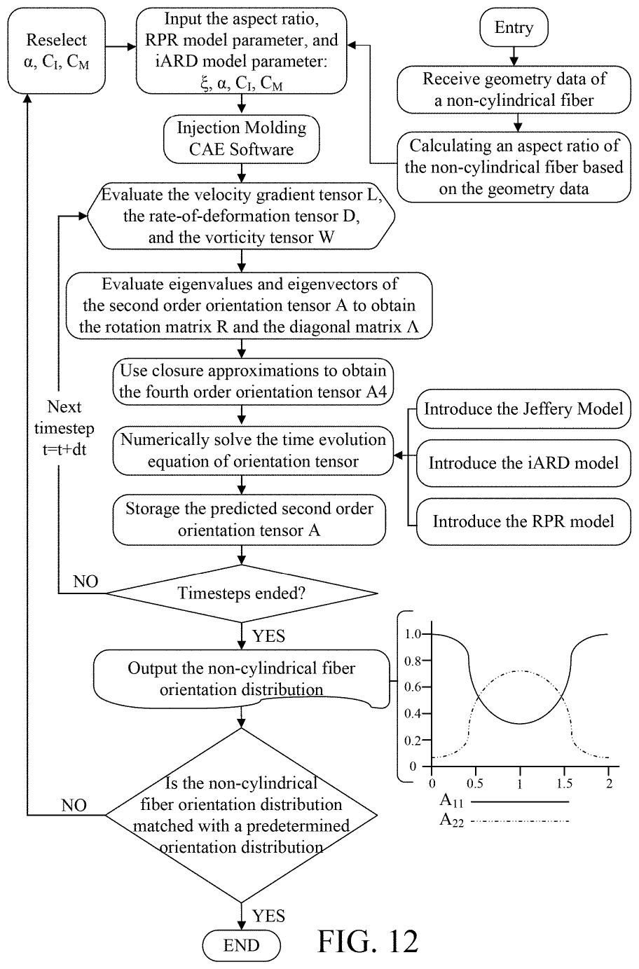

FIG. 12 is a flowchart showing an integration of the non-cylindrical fiber orientation prediction technique and the CAE software in accordance with some embodiments of the present disclosure. In some embodiments of the present disclosure, different parameters C_{I}, C_{M} and a may be selected for adjusting the non-cylindrical fiber orientation distribution to match to the predetermined orientation distribution.

The CAE software for injection molding can offer a velocity gradient tensor in the filling flow field for the subsequent fiber-orientation analysis. Thus, the orientation analysis is able to determine an acceptable orientation tensor. It is important that the constitutive equation for fibers obtains the orientation tensor to calculate the fiber suspension stress tensor. In the next step, this stress tensor is returned to the CAE software for updating. Therefore, in future work, the embodiment of the fiber orientation program will play an important role and is helpful in present CAE development of injection molding for fiber reinforced composites.

Although the present disclosure and its advantages have been described in detail, it should be understood that various changes, substitutions and alterations can be made herein without departing from the spirit and scope of the disclosure as defined by the appended claims. For example, the processors mentioned in the above embodiments may be a central processing unit (CPU), other hardware circuit elements capable of executing relevant instructions, or combination of computing circuits that shall be well-appreciated by those skilled in the art based on the above disclosures. Moreover, the memory mentioned in the above embodiments may be memories, such as ROM, RAM, etc., for storing data. Further, the input interface may be an I/O device, Human Input Device, etc. However, it is not intended to limit the hardware implementation embodiments of the present disclosure.

Furthermore, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A device for modeling fiber orientation distribution related to an injection molding object, comprising:
an input interface, being configured to receive first geometry data and first fiber data of a cylindrical fiber and to receive second geometry data and second fiber data of a non-cylindrical fiber; and
a processor, being connected to the input interface electrically and configured to:
derive a cylindrical fiber orientation distribution by inputting the first geometry data and the first fiber data of the cylindrical fiber into an orientation distribution generation model; where the cylindrical fiber orientation distribution has a first shell width and a first core width, wherein the first fiber data of the cylindrical fiber includes a first fiber-to-fiber interaction parameter, a first fiber-to-polymer interaction parameter, and a first fiber slow-down rate parameter;
select a second fiber data of the non-cylindrical fiber based on the first fiber data, the first shell width and the first core width of the cylindrical fiber, wherein the second fiber data includes a second fiber-to-fiber interaction parameter, a second fiber-to-polymer interaction parameter, and a second fiber slow-down rate parameter,
calculate an aspect ratio of the non-cylindrical fiber based on the second geometry data of the non-cylindrical fiber; and
derive a non-cylindrical fiber orientation distribution by inputting the aspect ratio and the second fiber data of the non-cylindrical fiber into the orientation distribution generation model, wherein the non-cylindrical fiber orientation distribution has a second shell width and a second core width, wherein the second core width is larger than the first core width, the second shell width is smaller than the first shell width.

2. The device of claim 1, wherein the processor is further configured to derive warpage data of the injection molding object by inputting the non-cylindrical fiber orientation distribution and the aspect ratio to a deformation model.

3. The device of claim 2, further comprising:
a memory, being connected to the processor electrically and configured to store the orientation distribution generation model and the deformation model.

4. The device of claim 1, wherein the geometry data further comprises a fiber length of the non-cylindrical fiber, a cross-sectional area of the non-cylindrical fiber, and a perimeter of a cross section of the non-cylindrical fiber, wherein the aspect ratio is calculated based on the following formula:
$$R = \frac{{L}_{F}}{( \frac{4 \times A}{P} )}$$
where R represents the aspect ratio, L_{F} represents the fiber length, A represents the cross-sectional area and P represents the perimeter.

5. (canceled)

6. The device of claim 1, wherein the non-cylindrical fiber orientation distribution matches the predetermined orientation distribution based on a cylindrical fiber orientation distribution.

7. The device of claim 6, wherein the predetermined orientation distribution and the cylindrical fiber orientation distribution comprise flow direction orientation distributions, and orientation tensor components of the predetermined orientation distribution are less than or equal to corresponding orientation tensor components of the cylindrical fiber orientation distribution at different thicknesses.

8. The device of claim 6, wherein the predetermined orientation distribution and the cylindrical fiber orientation distribution comprise cross-flow direction orientation distributions, and orientation tensor components of the predetermined orientation distribution are greater than or equal to corresponding orientation tensor components of the cylindrical fiber orientation distribution at different thicknesses.

9. An injection molding system, comprising:
a mold having a mold cavity;
a molding machine configured to fill the mold cavity with a composite molding resin including a polymeric material having a plurality of cylindrical fibers and a plurality of non-cylindrical fibers, wherein the cylindrical fibers have first geometry data and first fiber data and the non-cylindrical fibers have second geometry data and second fiber data;
a computing device, being connected to the molding machine and comprising:
a memory, being configured to store an orientation distribution generation model;
an input interface, being configured to receive the first geometry data and the first fiber data of a cylindrical fiber and the second geometry data and the second fiber data of a non-cylindrical fiber;
a processor, being connected to the memory and the input interface electrically and configured to:
derive a cylindrical fiber orientation distribution by inputting the first geometry data and the first fiber data of the cylindrical fiber into an orientation distribution generation model; where the cylindrical fiber orientation distribution has a first shell width and a first core width, wherein the first fiber data of the cylindrical fiber includes a first fiber-to-fiber interaction parameter, a first fiber-to-polymer interaction parameter, and a first fiber slow-down rate parameter;
select a second fiber data of the non-cylindrical fiber based on the first fiber data, the first shell width and the first core width of the cylindrical fiber; wherein the second fiber data includes a second fiber-to-fiber interaction parameter, a second fiber-to-polymer interaction parameter, and a second fiber slow-down rate parameter;
calculate an aspect ratio of the non-cylindrical fibers based on the second geometry data of the non-cylindrical fiber; and
derive a non-cylindrical fiber orientation distribution by inputting the aspect ratio and the second fiber data of the non-cylindrical fiber into the orientation distribution generation model, wherein the non-cylindrical fiber orientation distribution has a second shell width and a second core width, wherein the second core width is larger than the first core width, the second shell width is smaller than the first shell width;
a controller, being connected to the computing device and configured to control the molding machine to perform an actual molding for injecting the composite molding resin into at least a portion of the mold cavity based on the non-cylindrical fiber orientation distribution.

10. The injection molding system of claim 9, wherein the memory is further configured to store a deformation model, the processor is further configured to derive warpage data of an injection molding object by inputting the non-cylindrical fiber orientation distribution and the aspect ratio to the deformation model, and the controller is further configured to control the molding machine to perform the actual molding based on the non-cylindrical fiber orientation distribution and the warpage data.

11. A method for modeling fiber orientation distribution related to an injection molding object, comprising:
deriving a cylindrical fiber orientation distribution by inputting first geometry data and first fiber data of the cylindrical fiber into an orientation distribution generation model;
where the cylindrical fiber orientation distribution has a first shell width and a first core width, wherein the first fiber data of the cylindrical fiber includes a first fiber-to-fiber interaction parameter, a first fiber-to-polymer interaction parameter, and a first fiber slow-down rate parameter;
selecting a second fiber data of the non-cylindrical fiber based on the first fiber data, the first shell width and the first core width of the cylindrical fiber; wherein the second fiber data includes a second fiber-to-fiber interaction parameter, a second fiber-to-polymer interaction parameter, and a second fiber slow-down rate parameter;
obtaining an aspect ratio of a non-cylindrical fiber based on the second geometry data of the non-cylindrical fiber;
inputting the aspect ratio and second fiber data of the non-cylindrical fiber into the orientation distribution generation model for outputting a non-cylindrical fiber orientation distribution, wherein the non-cylindrical fiber orientation distribution has a second shell width and a second core width, wherein the second core width is larger than the first core width, the second shell width is smaller than the first shell width.

12. The method of claim 11, further comprising:
inputting the non-cylindrical fiber orientation distribution and the aspect ratio to a deformation model for outputting warpage data of the injection molding object.

13. The method of claim 11, wherein obtaining the aspect ratio further comprises:
receiving geometry data of the non-cylindrical fiber, and
calculating the aspect ratio of the non-cylindrical fiber based on the geometry data.

14. The method of claim 13, wherein the geometry data further comprises a fiber length of the non-cylindrical fiber, a cross-sectional area of the non-cylindrical fiber, and a perimeter of a cross section of the non-cylindrical fiber, wherein the aspect ratio is derived based on the following formula:
$$R = \frac{{L}_{F}}{( \frac{4 \times A}{P} )}$$
where R represents the aspect ratio, L_{F} represents the fiber length, A represents the cross-sectional area and P represents the perimeter.

15. (canceled)

16. The method of claim 11, wherein the predetermined orientation distribution is established according to a cylindrical fiber orientation distribution.

17. The method of claim 16, wherein the predetermined orientation distribution and the cylindrical fiber orientation distribution comprise flow direction orientation distributions, and an orientation tensor component of the flow direction orientation distribution of the predetermined orientation distribution is less than or equal to an orientation tensor component of the flow direction orientation distribution of the cylindrical fiber orientation distribution at a thickness.

18. The method of claim 16, wherein the predetermined orientation distribution and the cylindrical fiber orientation distribution comprise cross-flow direction orientation distributions, and the orientation tensor component of the cross-flow direction orientation distribution of the predetermined orientation distribution is greater than or equal to the orientation tensor component of the cross-flow direction orientation distribution of the cylindrical fiber orientation distribution at a thickness.

19. The method of claim 11, further comprising:
inputting the aspect ratio and second fiber data of the non-cylindrical fiber into the orientation distribution generation model for updating the non-cylindrical fiber orientation distribution; and
determining whether the non-cylindrical fiber orientation distribution corresponds to the predetermined orientation distribution.
